(19) United States
(12) Patent Application Publication
(10) Pub. No.: US 2004/0162843 A1
(43) Pub. Date: Aug. 19, 2004

(54) Method, system, and article of manufacture for evaluating an object

(75) Inventors: Pascal Ledru, Boulder, CO (US); Subramanya Kumar, Louisville, CO (US); Stephen A. Dirose, Broomfield, CO (US)

Correspondence Address: KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/371,614

(22) Filed: Feb. 19, 2003

(51) Int. Cl. G06F 17/00

(52) U.S. Cl. 707/101

(57) ABSTRACT

Provided are a method, system and article of manufacture for object evaluation. A criteria is received. A determination is made if an object includes an operation corresponding to the criteria. The determined included operation is executed. A result is generated based on the execution.

### BACKGROUND OF THE INVENTION

1. Field of the Invention

The present invention relates to a method, system, and an article of manufacture for evaluating an object.

2. Description of the Related Art

A notification system may accept an input, and depending on the input may determine whether or not to send a notification via a transport mechanism, such as, electronic mail or Simple Network Management Protocol (SNMP) trap. For example, a notification system, such as, an application program that monitors a group of computer systems may determine that the temperature of a monitored computer exceeds a threshold and the notification system may send an alarm to the system administrator in charge of the monitored computer. In another example, an application program, such as, a database search engine, may determine that certain airfares have fallen below a threshold and send a notification to an user.

Prior art notification systems may perform a comparison test of an input message or input event against a criteria and then forward a notification if the message or event conforms to the criteria. For example, the input event may be the temperature of a monitored computer and the criteria may indicate that an alarm should be generated if the temperature of a monitored computer exceeds a threshold. In object oriented programming languages, such as, Java*, the input message or input event may be embedded in a class. L6 *Java is a trademark of Sun Microsystems, Inc.

### SUMMARY

Provided are a method, system and article of manufacture for object evaluation. A criteria is received. A determination is made if an object includes an operation corresponding to the criteria. The determined included operation is executed. A result is generated based on the execution. In additional implementations, the determination further comprises introspecting the object.

In further implementations, the generated result is compared to the criteria. A response is determined based on the comparison. The response is sent. In yet additional implementations, the criteria is received via a notification contract, wherein the notification contract indicates a mechanism to send the response, wherein the response is sent via the indicated mechanism.

In additional implementations, the criteria is for monitoring at least one device and the object corresponds to the at least one device. In further implementations, the object corresponding to the at least one device is created, wherein the at least one device is monitored. The received criteria is split into one or more tokens, prior to the determination via introspection. The generated result is evaluated against the one or more tokens. Based on the evaluation, a response is sent.

In further implementations, the receiving, determining, executing and generating are performed by an application coded in an object oriented programming language that allows introspection.

The implementations use introspection to compare an object against one or more criteria. Modifications to the criteria do not require any change to the application that performs the comparison.

### BRIEF DESCRIPTION OF THE DRAWINGS

Referring now to the drawings in which like reference numbers represent corresponding parts throughout:

FIG. 1 illustrates a block diagram of a computing environment, in accordance with certain described aspects of the invention;

FIG. 2 illustrates a block diagram of a monitoring application and a monitored object, in accordance with certain described implementations of the invention;

FIG. 3 illustrates a block diagram of an exemplary user interface application, in accordance with certain described implementations of the invention;

FIG. 4 illustrates a block diagram of an exemplary user interface, in accordance with certain described implementations of the invention;

FIG. 5 illustrates a block diagram of a monitoring application, in accordance with certain described implementations of the invention;

FIG. 6 illustrates logic for dynamic object evaluation in a monitoring application, in accordance with certain described implementations of the invention;

FIG. 7 illustrates exemplary code fragments, in accordance with certain described implementations of the invention;

FIG. 8 illustrates an additional exemplary code fragment, in accordance with certain described implementations of the invention; and

FIG. 9 illustrates a block diagram of a computer architecture in which certain described aspects of the invention are implemented.

### DETAILED DESCRIPTION

In the following description, reference is made to the accompanying drawings which form a part hereof and which illustrate several implementations. It is understood that other implementations may be utilized and structural and operational changes may be made without departing from the scope of the present implementations.

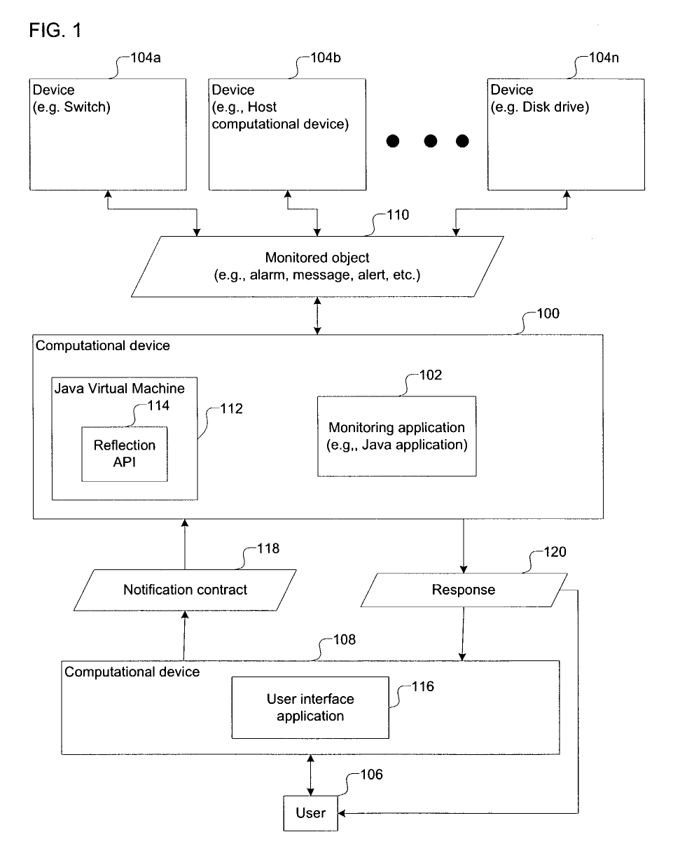

FIG. 1 illustrates a block diagram of a computing environment, in accordance with certain aspects of the invention. A computational device 100, including an application, such as, a monitoring application 102, is connected to a plurality of devices 104a . . . 104n. The monitoring application 102 monitors the devices 104a . . . 104n and may also communicate with a user 106 via a computational device 108 or via other means. In certain implementations, the monitoring application 102 may comprise a Java application. While the implementations describe a monitoring application 102, alternative implementations may include an application that is not a monitoring application. Furthermore, in alternative implementations the monitoring application 102 may monitor elements that are not devices.

The computational devices 100, 108, and the devices 104a . . . 104n may comprise any computational device known in the art, such as a personal computer, a workstation, a server, a mainframe, a hand held computer, a palm top computer, a telephony device, a network appliance, etc. The computational devices 100, 108, 104a . . . 104n may be interconnected by any network (not shown) known in the art, such as the Internet, an intranet, a Local area network (LAN), a Storage area network (SAN), a Wide area network (WAN), a wireless network, etc. The network may be part of one or more larger networks or may be an independent network or may be comprised of multiple interconnected networks. The computational device 100 may alternatively be connected to the devices 104a . . . 104n and the computational device 108 without a network, such as through direct lines, common bus systems, etc., in a manner known in the art.

Apart from comprising a computational device, the devices 104a . . . 104n may also comprise any hardware device known in the art, such as, a switch, a disk drive, etc. The devices 104a . . . 104n may also include devices or data structures implemented in software. A single object, such as, monitored object 110, that corresponds to the devices 104a . . . 104n allows the exchange of information between the devices 104a . . . 104n and the monitoring application 102. For example, the device 104b may send an event, such as, an alarm, a message, an alert, etc., via the monitored object 110 to the monitoring application 102 when the temperature of the device 104b exceeds a certain threshold. The monitored object 102 is a software object in an object oriented programming paradigm and a single monitored object may correspond to a plurality of events, alarms, messages, alerts, etc., generated by a plurality of devices 104a . . . 104n. The monitoring application 102 monitors the devices 104a . . . 104n by monitoring the monitored object 110. In certain implementations, the monitored object 110 may be an instance of a Java class and the monitoring application 102 may be a Java application.

In implementations where the monitoring application 102 is a Java application, the computational device 100 also comprises a Java Virtual Machine (JVM) 112. The JVM 112 may include implementations of the reflection application programming interface (API) 114 of the Java programming language. The reflection API 114 implements introspection in the Java programming language.

Introspection is the process of querying or examining the state or structure of an object in object oriented languages including Java. Introspection allows the explicit exposure of various features of an object, including the exposure of the features at runtime. For example, introspection can be used to find out about the objects available in a program, the name of the attributes in a particular object, the name and signature of the methods in a particular object, the run-time type of a particular object, etc. Introspection is implemented in the Java programming language by the java.lang.reflect package. Introspection via the reflection API 114 allows Java code to discover information about the fields, methods and constructors of loaded objects and dynamically invoke the loaded objects.

The reflection API 114 is designed for analyzing Java objects and classes at runtime. The monitoring application 102 performs introspection on the monitored object 110 via the reflection API 114. By performing introspection on the monitored object 110, the monitoring application 102 may discover methods of the monitored object 110 at runtime. Methods are operations, including functions, that may be performed on an object. While the implementations are described via the monitoring application 102 and the monitored object 110, the monitoring application 102 may be any application that can discover methods of an object. For example, a search engine application may discover methods of an object that relates to databases.

Computational device 108 includes a user interface application 116. The user 106 may interact with the user interface application and send a notification contract 118 to the monitoring application 102. The notification contract 118 includes the criteria under which the user 106 wants to be notified by the monitoring application 102. The criteria are conditions that relate to the state of the devices 104 . . . 104n being monitored by the monitoring application 102. In certain implementations the notification contract 118 may be an object in the Java programming language. The monitoring application 102 may send a response 120 to the user 106 either via the user interface application 116 or via other means. The response 120 is in response to the notifications requested by the user 106 via the notification contract 118.

Therefore, in the system described in FIG. 1, the monitoring application 102 monitors the devices 104a . . . 104n via the monitoring object 110. On the basis of a criteria received in the notification contract 118, the monitoring application 102 sends the response 120 the user 106.

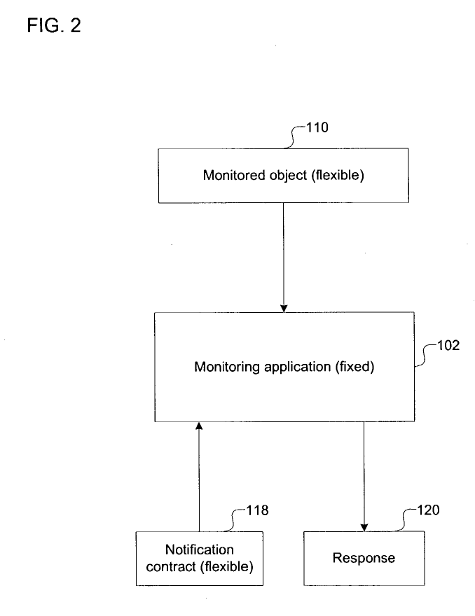

FIG. 2 illustrates a block diagram of the monitoring application 102 and the monitored object 110, in accordance with certain implementations of the invention. The monitored object 110 and the notification contract 118 are indicated as “flexible” because the monitored object 110 and the notification contract 118 are capable of being changed. For example, the user 106 may create a new notification contract 118. An earlier notification contract 118 may specify that a notification is required when the device 104a has a temperature beyond a threshold, whereas the new notification contract 118 may specify that a notification is required when the device 104b is a particular type of computer.

In contrast to the monitored object 110 and the notification contract 118 that are indicated as “flexible,” the monitoring application 102 is indicated as “fixed” because the code written and deployed for the monitoring application 102 on the computational device 100 does not have to be changed even when the notification contract 118 or monitored object 110 are changed.

Therefore, the implementations allow a fixed monitoring application 102 to handle flexible notification contracts 118 and a flexible monitored object 110 and send the appropriate response 120 to the user 106 based on the notification contract 118 and the monitored object 110. When the notification contract 118 or the monitored object 110 are altered, the monitoring application 102 does not have to be modified with new comparison tests. The monitoring application 102 receives the modified notification contract 118 and introspects the monitored object 110 to determine whether the monitored object 110 includes methods corresponding to monitoring criteria included in the notification contract 118. The monitoring application 102 executes the methods corresponding to the monitoring criteria and sends the response 120 to the user 106. In alternative implementations an application introspects an object to determine whether the object includes methods corresponding to a criteria. The application executes the methods corresponding to the criteria and sends a response to the user 106.

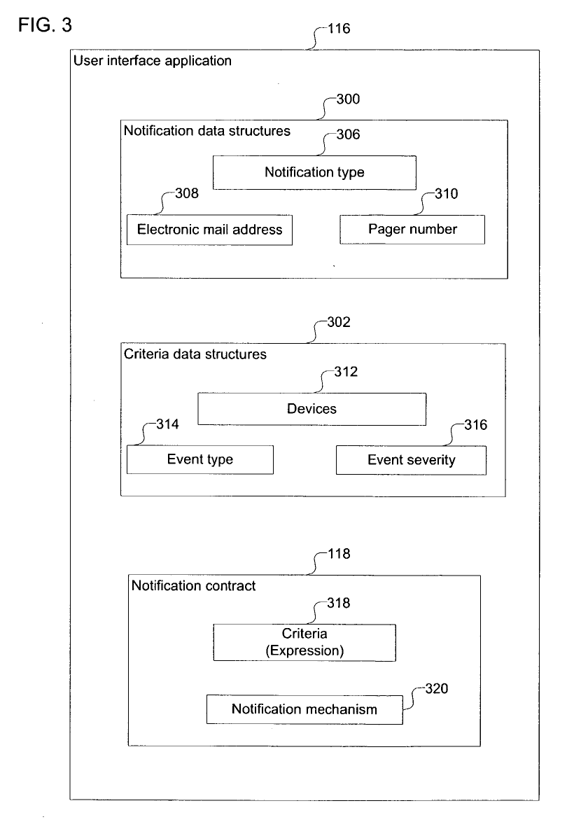

FIG. 3 illustrates a block diagram of an implementation of the user interface application 116, in accordance with certain implementations of the invention. The user interface application 116 may include notification data structures 300, criteria data structures 302 and the notification contract 118.

The notification data structures 300 comprise a field indicating notification type 306, and fields for exemplary notification types including an electronic mail address 308, and a pager number 310. The user 106 may enter the field for the notification type 306 as an electronic mail or a pager. The field for the electronic mail address 308 may include the entry of the actual electronic mail address of the user 106, and the field for the pager number 310 may include the entry of the actual pager number of the user 106. For example, if the notification type 306 is “electronic mail” and the entry corresponding to the electronic mail address 308 is the electronic mail address of the user 106, then monitoring application 102 sends the response 120 to the user 106 by sending an electronic mail to the entry corresponding to the electronic mail address 308. Therefore, the notification data structures 300 includes the notification mechanisms to be used to notify the user 106. The notification data structures 300 and other data structures included in the user interface application 116 may be different for different types of notification protocols. For example, the notification data structures of FIG. 3 may be different for an SNMP notification protocol.

In FIG. 3, the criteria data structures 302 includes a field for devices 312 that can include an indication that corresponds to the devices 104a . . . 104n. Each device 312 field includes a list of event types 314 and event severities 316 for which notifications are requested from the monitoring application 102 by the user 106. For example, the field for devices 312 may indicate the device 104a, the event type 314 may be an error message generated by the device 104a, and the event severity 316 may be “high.” In such a case, the monitoring application 102 will generate the response 120 for the user 106, when the device 104a generates an error message with a “high” severity. Therefore, the criteria data structures 302 include the criteria for which the devices 104a . . . 104n are to be monitored.

The notification contract 118 includes a criteria 318 and a notification mechanism 320. The criteria 318 corresponds to the criteria for monitoring included in the criteria data structures 302. The notification mechanism 320 corresponds to the notification mechanisms included in the notification data structures 300. The user 106 creates the notification contract 118 by interacting with the user interface application 116. The notification contract 118 is sent to the monitoring application 102 by the user interface application 116.

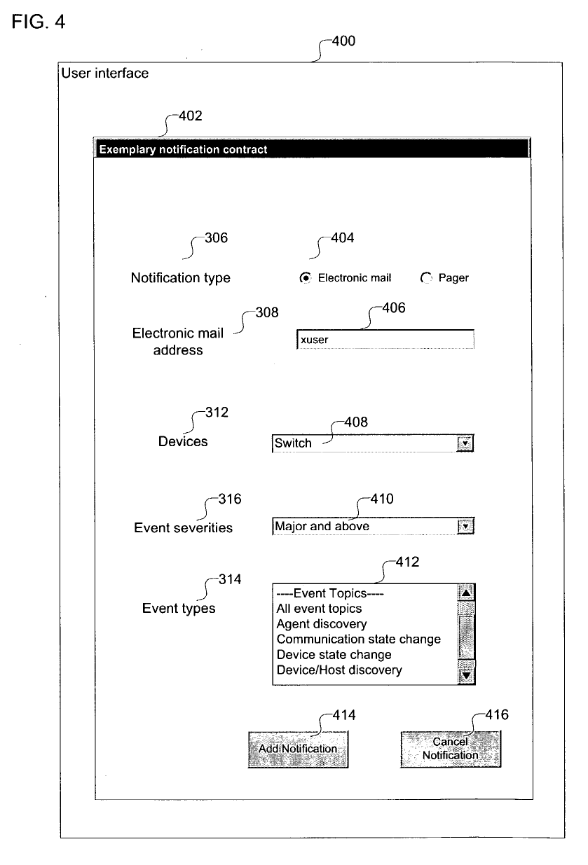

FIG. 4 illustrates a block diagram of an exemplary user interface 400 generated by the user interface application 116, in accordance with certain implementations of the invention. The user interface 400 displays an exemplary notification contract 402 corresponding to the notification contract 118. In certain implementations, the user 106 completes the exemplary notification contract 402 by interacting with the user interface 400. In alternative implementations, instead of interacting with the user interface 400, the user 106 may create a script that corresponds to the data entered for completing the exemplary notification contract 402.

In the exemplary notification contract 402 the notification type 306 is electronic mail 404. The electronic mail address 308 is “xuser.” Therefore, the monitoring application 102 sends the response 120 to the user 106 at email address “xuser.”

The user 106 interacts with the exemplary user interface 400 and selects a criteria 318 included in the exemplary notification contract 402 by selecting various combinations of devices 312, event severities 316 and event types 314. For example, the user 106 may select that for certain “event topics” 412 in the switch 408 notifications should be generated for “major and above” 410 event severities.

The user 106 may make a selection of “add notification” 414 to add a notification to the exemplary notification contract 402. The user 106 may make a selection of “cancel notification” 416 to cancel a notification in the exemplary notification contract 402.

Therefore, the user 106 generates the exemplary notification contract 402 by interacting with the user interface 400 displayed on the computational device 108. The exemplary notification contract 402 includes the criteria 318 and notification mechanism 320 indicated by the user 106.

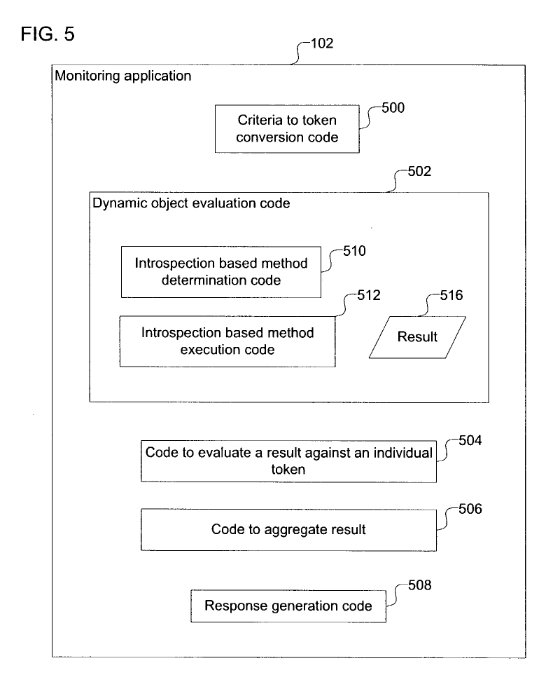

FIG. 5 illustrates a block diagram of the monitoring application 102, in accordance with certain implementations of the invention. The monitoring application 102 may be written in any object oriented language that provides for introspection of objects, including the Java programming language.

The monitoring application 102 includes a criteria to token conversion code 500, a dynamic object evaluation code 502, a code to evaluate a result against an individual token 504, a code to aggregate result 506, and a response generation code 508.

The criteria to token conversion code 500, splits the criteria 318 received via the notification contract 118 at the monitoring application 102 into individual tokens. For example, if the criteria 318 indicates that a response is required for severities of level greater than three when the device is of type “SUN”, then in one implementation the tokens may be “computerType=SUN” and “Severity>3.” The names included in the tokens such as “computerType” and “Severity” may correspond to methods in the monitored object 110. For example, the monitored object 110 may have a method “getcomputerType” that returns the computer type and a method “getSeverity” that returns the severity.

The dynamic object evaluation code 502 includes introspection based method determination code 510, introspection based method execution code 512 and a data structure for result 516. The introspection based method determination code 510 determines via introspection if the monitored object 110 includes methods corresponding to the criteria 318. The introspection based method execution code 512 executes the determined method and generates the result 516. The result 516 indicates the state of a device 104a . . . 104n corresponding to the criteria 318. For example, the result 516 may indicate that the computer type of a device is “SUN”.

The code to evaluate a result against an individual token 504 compares the result 516 to the conditions in the individual tokens. For example, if the result 516 indicates that the computer type of a device is “SUN”, then the code to evaluate the result against an individual token 504 may determine that the token “computerType=SUN” is satisfied. Subsequently, the code to aggregate result 506 aggregates a plurality of evaluated results, i.e., a plurality of results 516 are compared to a plurality of tokens to determine if the results 516 satisfy the criteria 318. The response generation code 508 sends the response 120 to the user 106 from the monitoring application 102.

In alternative implementations, the criteria 318 need not be split into tokens. As long as the criteria 318 includes any indicator that corresponds to method names included in the monitored object 110 the indicators may be extracted in ways that do not involve the extraction of individual tokens.

Therefore, an application, such as, the monitoring application 102, receives the criteria 318 from the user 106 and determines the methods corresponding to the criteria 318 via introspection of the monitored object 110. The monitoring application 102 executes the methods and determines the response 120.

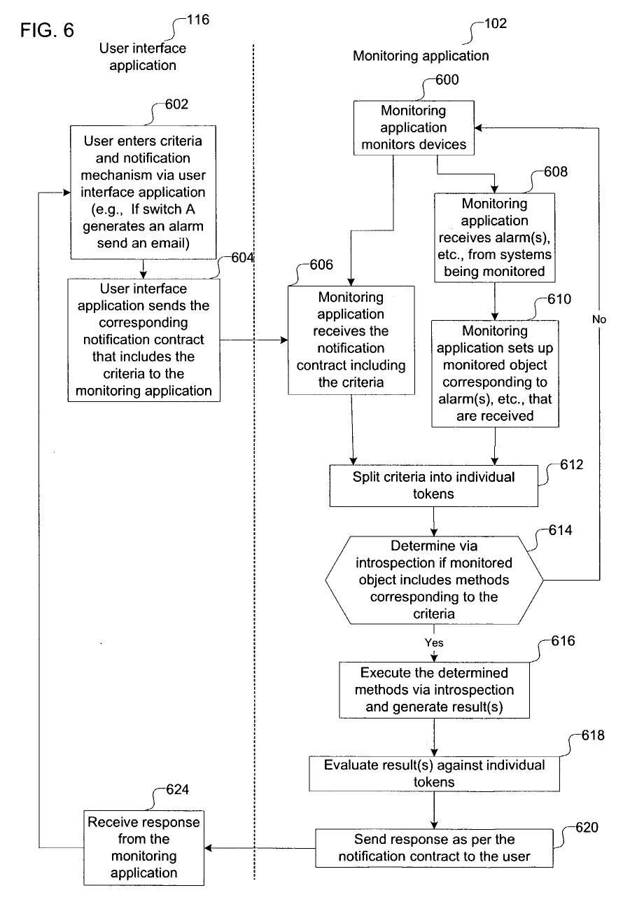

FIG. 6 illustrates logic for dynamic object evaluation in the monitoring application 102, in accordance with certain implementations of the invention. The process starts at block 600 with the monitoring application 102 monitoring the devices 104a . . . 104n. While the monitoring application 102 is monitoring the devices 104a . . . 104n, the user 106 enters (at block 602) the criteria 318 and notification mechanism 320. For example, the user 106 may indicate that an electronic mail should be sent if switch A generates an alarm.

From block 602, control proceeds to block 604 where the user interface application 116 sends the corresponding notification contract 118 that includes the criteria 318 and the notification mechanism 320 to the monitoring application 102. Control proceeds to block 606, where the monitoring application 102 receives the notification contract 118 including the criteria 318.

Simultaneously with or prior to the execution of blocks 602, 604 and 606, control proceeds from block 600 to block 608 where the monitoring application 102 receives events, including alarms, alerts, and other messages from the devices 104a . . . 104n that the monitoring application 102 monitors. Control proceeds to block 610 where the monitoring application 102 initializes or updates the monitored object 110 corresponding to the events being monitored. The logic of blocks 600, 608 and 610 may be performed by the monitoring application 102 at the time the monitoring application 102 starts monitoring the devices 104a . . . 104n.

From blocks 606 and 610 control proceeds to block 612, where the monitoring application 102 splits the criteria 318 into individual tokens. Control proceeds to block 614, where the monitoring application 102 determines via introspection if the monitored object 110 includes methods corresponding to the criteria 318. If at block 614, the determination is that the monitored object 110 includes methods corresponding to the criteria 318, then control proceeds to block 616. At block 616, the monitoring application 102 executes the determined methods via introspection and generates result(s). The monitoring application 618 evaluates (at block 618) the results(s) against the individual tokens to determine the response to the user 106. Control proceeds to block 620, where the monitoring application sends the response 120 as per the notification contract 118 to the user 106. The user 106 receives (at block 624) the response 120 from the monitoring application 102.

If at block 614, the determination is that the monitored object does not include methods corresponding to the criteria 318, then control proceeds to block 600 where the monitoring application 102 continues monitoring the devices 104a . . . 104n.

Therefore, the monitoring application 102 receives a criteria 318 for monitoring devices from a user 106. The monitoring application 102 determines via introspection if the monitoring object 10 includes a method corresponding to the criteria 318. The monitoring application 102 executes the determined method and generates a result based on the execution. Based on the aggregation of a plurality of results the monitoring application 102 generates the response 120 for the user 106. In alternative implementations, the criteria 318 is not limited to the monitoring of devices and the monitoring application 102 may be any application that determines via introspection if an object includes a method corresponding to the criteria 318.

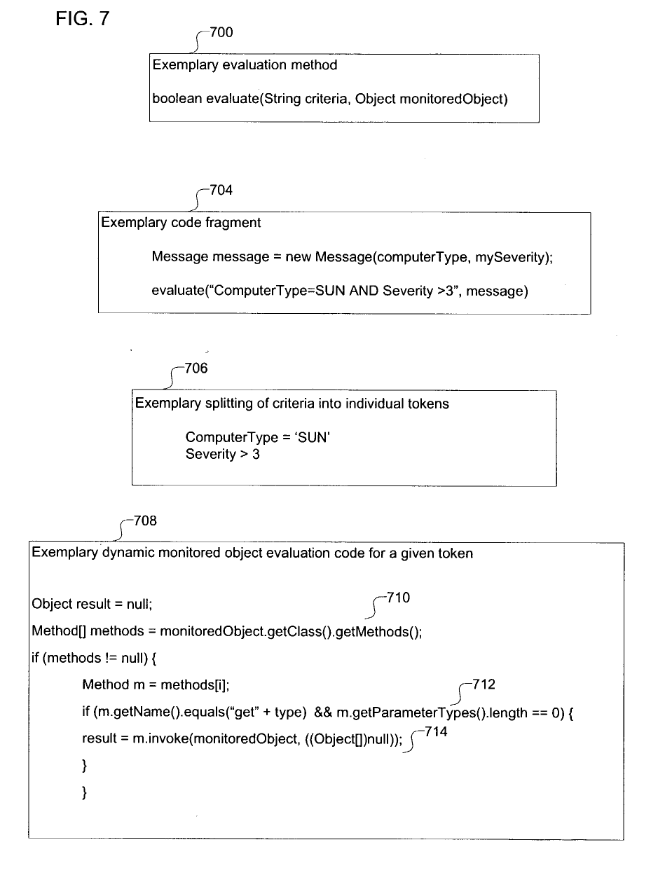

FIG. 7 illustrates exemplary code fragments in the Java programming language, in accordance with certain implementations of the invention. An exemplary evaluation method 700 includes a method “evaluate” that takes the criteria 318 and the monitored object 110 as parameters. The “evaluate” method is implemented in the monitoring application 102 and determines whether or not the results of executing the methods of the monitored object 110 matches the criteria 318.

An exemplary code fragment 704 calls the method evaluate when the computer type is “SUN” and the severity of the message is greater than 3. The exemplary code fragment 704 illustrates a particular criteria.

An exemplary splitting of the criteria into individual tokens 706 that corresponds to the exemplary code fragment 704 shows the tokens as “ComputerType=SUN” and “Severity>3”.

An exemplary dynamic monitored object evaluation code for a given token 708 may call the methods getComputerType( ) and getSeverity( ) that correspond to the exemplary code fragment 704 and the exemplary splitting of criteria into individual tokens 706 via introspection and execute the appropriate method. Line 710 gets the methods of the monitored object 110 via introspection. Lines 712 and 714 may execute the method corresponding to a token via the invoke method known in the art in the reflection API 114. For example, the method getComputerType( ) or getSeverity( ) may be executed on the monitored object 110.

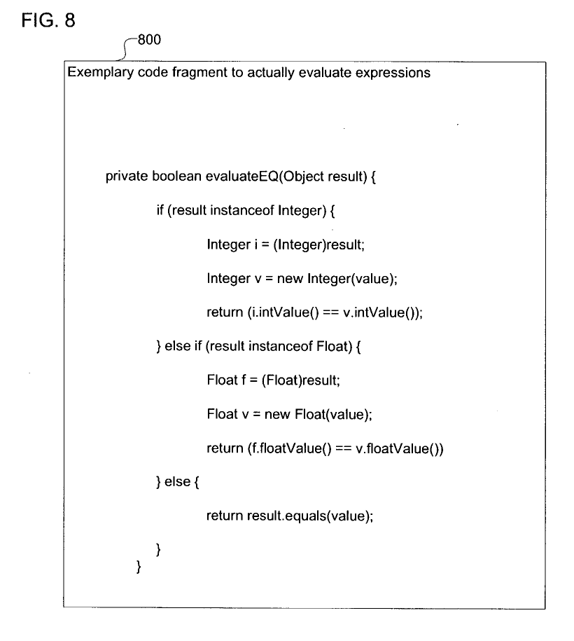

FIG. 8 illustrates an additional exemplary code fragment, in accordance with certain implementations of the invention. An exemplary code fragment to actually evaluate expressions 800 is illustrated. The code fragment 800 determines via the method evaluateEQ whether the result 516 matches a condition as reflected in a particular token. For example, the code fragment 708 may return 3 when getseverity( ) is executed. The code fragment 800 may determine whether the Severity equals 3.

The code fragments of FIGS. 7 and 8 may be written in a variety of ways and in other object oriented programming languages besides Java. Equivalent representations may also be created in non-object oriented languages.

The implementations use introspection to dynamically evaluate input events in a notification system that comprises a monitoring application. Modifications to the notification criteria and the input events do not require any change to the monitoring application. When a new criteria is encountered by the monitoring application the monitoring application introspects the monitoring object to determine whether a method corresponding to the new criteria exists. If so, the monitoring application executes the determined method and obtains the result. The monitoring application compares the result to the criteria and generates a notification. Therefore, there is no need to change the monitoring application after deployment. Additionally, the monitoring application can handle complex criteria that includes multiple conditions.

While the implementations have been described with respect to a monitoring application, the implementations may include any application that receives a criteria from a user. The application determines via introspection if an object includes an operation, i.e., a method, corresponding to the criteria. The application executes the determined operation and generates a result based on the execution. The application further compares the generated result to the criteria and determines a response. The response is sent to the user. Therefore, the implementations use introspection to compare an object against one or more criteria. Modifications to the criteria do not require any change to the application that performs the comparison.

The described techniques may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code for the implementations may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

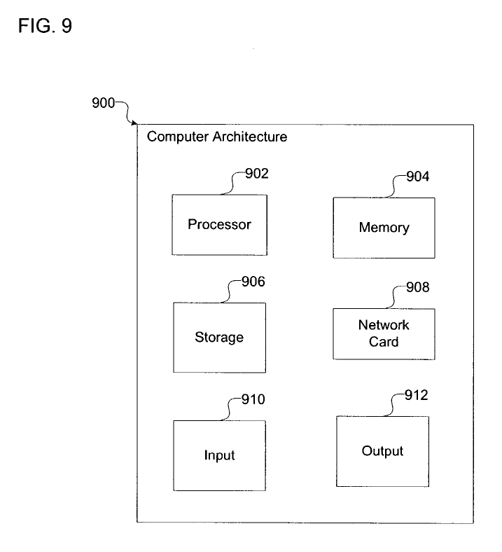

FIG. 9 illustrates a block diagram of a computer architecture in which certain aspects of the invention are implemented. FIG. 9 illustrates one implementation of the computational devices 100 and 108, and the computational devices that maybe included in the devices 104a . . . 104n. The computational devices 100, 108 and the computational devices that may be included in the devices 104a . . . 104n may implement a computer architecture 900 having a processor 902, a memory 904 (e.g., a volatile memory device), and storage 906 (e.g., a non-volatile storage, magnetic disk drives, optical disk drives, tape drives, etc.). The storage 906 may comprise an internal storage device, an attached storage device or a network accessible storage device. Programs in the storage 906 may be loaded into the memory 904 and executed by the processor 902 in a manner known in the art. The architecture may further include a network card 908 to enable communication with a network. The architecture may also include at least one input 910, such as a keyboard, a touchscreen, a pen, voice-activated input, etc., and at least one output 912, such as a display device, a speaker, a printer, etc.

The logic of FIGS. 6-8 describe specific operations occurring in a particular order. Further, the operations may be performed in parallel as well as sequentially. In alternative implementations, certain of the logic operations may be performed in a different order, modified or removed and still implement implementations of the present invention. Morever, steps may be added to the above described logic and still conform to the implementations. Yet further steps may be performed by a single process or distributed processes.

The computational devices 100, 108 and the devices 104a . . . 104n communicate within a client-server paradigm in the described implementations, the computational devices 100, 108 and the devices 104a . . . 104n may also communicate within a peer-to-peer or any other paradigm known in the art. In the implementations, responses have been sent to an user. In alternative implementations, the responses may be stored in log files or may sent to an entity other than the user. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures, applications, agents, and components show in FIGS. 1-9 are shown as having specific types of information. In alternative implementations, the data structures, agents, and components may be structured differently and have fewer, more or different fields, components or functions than shown in the figures.

Therefore, the foregoing description of the implementations has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

What is claimed is:

1. A method for object evaluation, comprising:
receiving a criteria;
determining if an object includes an operation corresponding to the criteria;
executing the determined included operation; and
generating a result based on the execution.

2. The method of claim 1, wherein the determination further comprises introspecting the object.

3. The method of claim 1, further comprising:
comparing the generated result to the criteria;
determining a response based on the comparison; and
sending the response.

4. The method of claim 3, wherein the criteria is received via a notification contract, wherein the notification contract indicates a mechanism to send the response, and wherein the response is sent via the indicated mechanism.

5. The method of claim 1, wherein the criteria is for monitoring at least one device and the object corresponds to the at least one device.

6. The method of claim 5, further comprising:
creating the object corresponding to the at least one device, wherein the at least one device is monitored;
splitting the received criteria into one or more tokens, prior to the determination;
evaluating the generated result against the one or more tokens; and
based on the evaluation, sending a response.

7. The method of claim 5, wherein a notification contract indicates the at least one device, and at least one event type associated with the at least one device for which a notification is desired.

8. The method of claim 1, wherein the receiving, determining, executing and generating are performed by an application coded in an object oriented programming language that allows introspection.

9. The method of claim 1, wherein an application performing the receiving, determining, executing, and generating is implemented in a computational system, wherein the same application may perform the receiving, determining, executing, and generating for a plurality of criteria.

10. The method of claim 1, wherein the criteria includes conditions for monitoring at least one device for events including alarms, alerts and error conditions.

11. The method of claim 1, wherein the criteria includes an indication of at least one operation that is included in the object that corresponds to at least one device that is monitored, and wherein the object may correspond to a plurality of devices that are monitored.

12. A system for object evaluation, comprising:
an object;
means for receiving a criteria;
means for determining if the object includes an operation corresponding to the criteria;
means for executing the determined included operation; and
means for generating a result based on the execution.

13. The system of claim 12, wherein the means for determining further performs:
introspecting the object.

14. The system of claim 12, further comprising:
means for comparing the generated result to the criteria;
means for determining a response based on the comparison; and
means for sending the response.

15. The system of claim 14, wherein the criteria is received via a notification contract, wherein the notification contract indicates a mechanism to send the response, wherein the response is sent via the indicated mechanism.

16. The system of claim 12, further comprising:
at least one device, wherein the criteria is for monitoring the at least one device and the object corresponds to the at least one device.

17. The system of claim 16, further comprising:
means for creating the object corresponding to the at least one device, wherein the at least one device is monitored;
means for splitting the received criteria into one or more tokens, prior to the determination;
means for evaluating the generated result against the one or more tokens; and
means for sending a response, based on the evaluation.

18. The system of claim 16, wherein a notification contract indicates the at least one device, and at least one event type associated with the at least one device for which a notification is desired.

19. The system of claim 12, wherein the receiving, determining, executing and generating are performed by an application coded in an object oriented programming language that allows introspection.

20. The system of claim 12, wherein an application performing the receiving, determining, executing, and generating is implemented in a computational system, wherein the same application may perform the receiving, determining, executing, and generating for a plurality of criteria.

21. The system of claim 12, wherein the criteria includes conditions for monitoring at least one device for events including alarms, alerts and error conditions.

22. The system of claim 12, wherein the criteria includes an indication of at least one operation that is included in the object that corresponds to at least one device that is monitored, and wherein the object may correspond to a plurality of devices that are monitored.

23. An article of manufacture for object evaluation, wherein the article of manufacture is capable of causing operations, the operations comprising:
receiving a criteria;
determining if an object includes an operation corresponding to the criteria;
executing the determined included operation; and
generating a result based on the execution.

24. The article of manufacture claim 23, wherein the determination further comprises introspecting the object.

25. The article of manufacture of claim 23, the operations further comprising:
comparing the generated result to the criteria;
determining a response based on the comparison; and
sending the response.

26. The article of manufacture of claim 25, wherein the criteria is received via a notification contract, wherein the notification contract indicates a mechanism to send the response, wherein the response is sent via the indicated mechanism.

27. The article of manufacture of claim 23, wherein the criteria is for monitoring at least one device and the object corresponds to the at least one device.

28. The article of manufacture of claim 27, the operations further comprising:
creating the object corresponding to the at least one device, wherein the at least one device is monitored;
splitting the received criteria into one or more tokens, prior to the determination;
evaluating the generated result against the one or more tokens; and
based on the evaluation, sending a response.

29. The article of manufacture of claim 27, wherein a notification contract indicates the at least one device, and at least one event type associated with the at least one device for which a notification is desired.

30. The article of manufacture of claim 23, wherein the receiving, determining, executing and generating are performed by an application coded in an object oriented programming language that allows introspection.

31. The article of manufacture of claim 23, wherein an application performing the receiving, determining, executing, and generating is implemented in a computational system, wherein the same application may perform the receiving, determining, executing, and generating for a plurality of criteria.

32. The article of manufacture of claim 23, wherein the criteria includes conditions for monitoring at least one device for events including alarms, alerts and error conditions.

33. The article of manufacture of claim 23, wherein the criteria includes an indication of at least one operation that is included in the object that corresponds to at least one device that is monitored, and wherein the object may correspond to a plurality of devices that are monitored.
